(19) United States
(12) Patent Application Publication
(10) Pub. No.: US 2003/0219297 A1
(43) Pub. Date: Nov. 27, 2003

(54) Newspaper producing method

(76) Inventor: Hideo Izawa, Narashino-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/317,099

(22) Filed: Dec. 12, 2002

(30) Foreign Application Priority Data
May 24, 2002 (JP) P2002-150842

(51) Int. Cl. B41J 3/60

(52) U.S. Cl. 400/188

(57) ABSTRACT

A newspaper producing method of the present invention can produce a plurality kinds of newspapers different in page numbers and colors by using a single printing unit. This method includes a plurality of printing cycles, each in which a plurality of lateral printing rows having different contents from each other and each having at least two printing surfaces in a width direction of the continuous web are printed on both sides of the continuous web correspondingly to each other, the printed continuous web is cut with respect to each of the lateral printed rows and each tow-page spread of newspaper, and the cut webs are set and are delivered at every printing cycle. Each set of the webs is folded at a longitudinal central portion of two-page spread thereof.

### BACKGROUND OF THE INVENTION

1. Field of the Invention

The present invention relates to a method of producing newspaper having a number of pages such as 16 pages, 32 pages, 40 pages, etc.

2. Related Art

In a known art, newspaper is produced by steps of printing a continuous web of paper in form of double-width size web sheet (laterally corresponding to four pages of newspaper) by using a rotary press, slitting the printed continuous web in its longitudinal direction into two portions (each laterally corresponding to two pages of newspaper) by using a slitter, overlapping the two portions and then folding them in their longitudinal direction by using a former, cutting the folded paper web in its transverse direction so as to have a predetermined vertical length of the newspaper and then delivering the same.

FIG. 4 shows a process explaining the above newspaper producing steps by using a blanket-blanket type offset rotary press. With reference to FIG. 4, the offset rotary press includes two opposed plate cylinders a which each is mounted with a printing plate having two lateral printing rows juxtaposed in the circumferential direction, each having four printing surfaces adapted to print four pages of A, B, C and D or E, F, G and H of the newspaper in the axial direction of the plate cylinder, and according to complete rotations of two opposed blanket cylinders b, the continuous web of paper c (which will be called hereinlater “continuous web” or merely “web”) is printed by 8 pages on respective surfaces of both sides of the continuous web. In such case, the continuous web c has a width twice the lateral width of the newspaper having four pages when the latter is opened, i.e. 1625 mm (64 inches).

Thereafter, by using a slitter, the continuous web c is slit into two portions in the longitudinal direction at an intermediate portion in the width direction of the web, and the two portions are overlapped at a gathering (collecting) section using a turn bar e. Thereafter, the overlapped portions are folded in folio in the longitudinal direction by using a former f, and then, the folded web is cut with respect to each row to thereby produce two kinds of newspapers each including 8 pages, alternately in order.

At a time when the newspaper is produced by using the printing unit of the plate cylinder structure mentioned above, supposing that one printing unit has an ability for printing, for example, two kinds of 8 pages, such as mentioned above, when a newspaper of 16, 32 or 40 pages is printed, it is obliged to use two-unit type, three-unit type or four-unit type rotary press having these two kinds of 8-page printing units of which the number is increased to two (2), three (3) or 4 (four).

FIG. 5 shows a 4-unit type rotary press including four printing units g₁, g₂, g₃ and g₄. Each of the continuous webs c printed respectively at the printing units g₁ to g₄ is divided into two parts at a slitter h and then they are gathered by using a turn bar group of a collection unit i. Thereafter, the continuous webs c are folded in folio by the former f and then again folded by a folding apparatus j.

As mentioned hereinbefore, when the newspaper is produced by using a conventional plate-cylinder type printing unit, it is necessary to increase the number of the printing unit every time when the number of the pages of the newspaper is increased, thus being disadvantageous in producing cost and installation space. Particularly, the four-unit type rotary press such as shown in FIG. 5 is made considerably large in size, and hence, it requires large installation space and is, moreover, expensive.

Furthermore, in such conventional printing unit, it is difficult to increase pages of the newspaper after the first setting thereof because of limitation in installation space. Moreover, in multi-color printing, since a number of printing units are required and hence traveling path for the continuous web is extremely elongated, there causes losses in paper and time only in a paper threading process, and furthermore, much paper (web) loss is caused till the tension is stabilized and different color registration is made. In addition, it is required to change a printing plate every time when a content to be printed is changed, which will not be profitable in a production of a little number of lots.

### SUMMARY OF THE INVENTION

An object of the present invention is to substantially eliminate defects or drawbacks encountered in the prior art mentioned above and to provide a newspaper producing method capable of producing a plurality kinds of newspapers including page numbers and colors different from each other by utilizing a single printing unit, the method being profitable in a printing of small number of lots.

This and other objects can be achieved according to the present invention by providing a method of producing newspaper comprising the steps of:

printing both sides of continuous web repeatedly in a printing direction, the printing step including a plurality of printing cycles each in which a plurality of lateral printing rows having different contents from each other and each having at least two printing surfaces in a width direction of the continuous web, are printed on both sides of the continuous web correspondingly to each other;

cutting the printed continuous web with respect to each of the lateral printed rows and each two-page spread of newspaper and setting and delivering a set of the cut webs at every printing cycle; and

folding each set of the cut webs at a longitudinally central portion of two-page spread thereof;

whereby a newspaper of pages corresponding to the printing cycle is repeatedly produced.

In a preferred embodiment of this newspaper producing method, both sides of the continuous web are printed at a portion thereof traveling in a vertical direction. The printing step is performed by using a digital printing machine including printing heads opposite to both sides of the continuous web, respectively, the printing head being arranged opposite to each other at the same level in the printing direction. The printing step may be also performed by using a digital printing machine including printing heads opposite to both sides of the continuous web, the printing head being arranged at different levels offset in the printing direction.

According to the present invention of the characters mentioned above, both sides of continuous web are printed repeatedly, by using a digital printing machine, in a printing direction such that the printing step includes a plurality of printing cycles each in which a plurality of lateral printing rows having different contents from each other and each having at least two printing surfaces in a width direction of the continuous web, are printed on both sides of the continuous web correspondingly to each other. Therefore, the number of the printing rows in the printing direction in the printing cycle mentioned above can be changed, and hence, it becomes possible to optionally produce newspapers different in pages and/or colors by using one set of web feeding section and printing section. Thus, it is not necessary to increase the number of the printing units, as in the conventional printing method using a rotary press, in conformity with the pages and/or colors, and hence, according to the present invention, the newspaper can be produced at the reduced producing cost and reduced printing system installation space.

Moreover, the use of the digital printing machine makes it possible to easily change the contents to be printed without changing a printing plate or the like as in the conventional rotary press, and accordingly, only one lot printing can be performed with commercial profit.

Furthermore, since the multi-color printing can be performed by using the digital printing machine which is compact, it is allowed for the printing system to have a reduced web traveling path and to be operated with stable tension and reduced paper (web) loss in web feeding process or different color registration process.

Further, the above and other objects, many other characteristic features and advantageous effects and the like of the present invention will be made more clear from the following descriptions made with reference to the accompanying drawings.

### BRIEF DESCRIPTION OF THE DRAWINGS

In the accompanying drawings:

FIG. 1 is an illustration for explanation of one embodiment according to the present invention;

FIG. 2 is a schematic view showing a setting and delivering section and a chopper folding section of a printing system for explaining the embodiment of the present invention;

FIG. 3 is a view viewed by an arrow X in FIG. 2;

FIG. 4 is a schematic view of a printing system of conventional structure; and

FIG. 5 is a front view of a conventional rotary press.

### DESCRIPTION OF THE PREFERRED EMBODIMENT

One embodiment of the present invention will be described hereunder with reference to a case of producing newspaper of 32 pages which is foldable in folio.

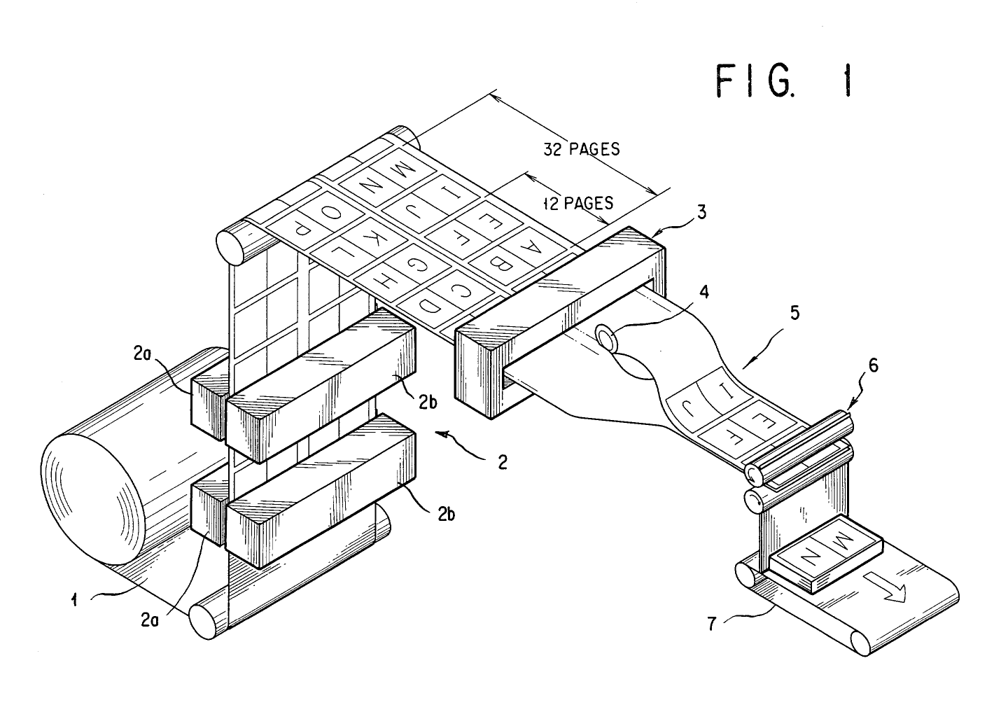

With reference to FIG. 1, reference numeral 1 denotes a continuous web for double-width type newspaper. The continuous web 1 is subjected to double-side surface (perfect) printing by a double-side printing machine 2 disposed to a printing section, and the web 1 is dried by passing through a drier 3 and then split into two parts in the longitudinal direction thereof by a splitter 4. Thereafter, the two parts are overlapped at a gathering section 5 by using a turn bar, not shown, then cut by a cutter 6 so as to have a predetermined length (vertical dimension of the newspaper) and, thereafter, stacked on a conveyer 7 for making sets of newspapers each composed of the predetermined number of papers. The newspaper sets on the conveyer 7 are delivered and discharged in a shifted state every newspaper set.

The double-side printing machine 2 is arranged at a position at which the continuous web 1 is traveling in substantially vertical direction. This double-side printing machine 2 employs a digital printer such as ink-jet printer or electro-photography printer which can change, at random, the content in each page of the newspaper to be printed by using an on-demand controller without using printing plates.

The double-side printing machine 2 has printing heads 2a and 2b, at least one of which is disposed opposed to each of both (two) sides of the continuous web 1. However, in a case of large volume of printing contents or multi-color printing, the two-four printing heads may be additionally arranged along the printing direction (traveling direction of the continuous web 1) as occasion demands.

Further, it is not absolutely necessary for the printing heads 2a and 2b disposed on the respective sides in the opposing manner to be arranged at the same positions along the printing direction, and the printing heads 2a and 2b may be arranged in an offset manner in the printing direction as far as the printing timing of both the printing heads could be controlled so that both the printing surfaces of both sides of the newspaper correspond to each other.

At the both-side printing section by using the both-side printing machine 2, one side of the continuous web 1 is printed with printing surfaces being arranged in four lateral rows juxtaposed in the printing direction, each including four printing surfaces of pages A-D, E-H, I-L or M-P, and this four-row printing is repeatedly carried out. On the other hand, the other side of the continuous web 1 is also printed in the manner substantially identical to that mentioned above. That is, four lateral rows, each including four printing surfaces corresponding to those of the above mentioned one side, are printed in the printing direction, and this lateral four-row printing is repeatedly carried out, and a pair of four-row printings on both sides of the continuous web 1 are carried out as one printing cycle for the newspaper, and this cycle is repeated so as to print the required number of newspaper sets.

With reference to FIG. 1, the continuous web 1 of double-width size (including lateral 4 pages of newspaper), after images have been printed on its both sides, is then dried by the drier 3. The continuous web 1 of double-width size is slit into two parts by means of slitter 4 so as to provide two continuous webs each having two-page spread width of the newspaper, which are then superimposed as two-ply web at the gathering section 5. Thereafter, the superimposed continuous web 1 are cut by the cutter 6 so as to provide two-page spread of newspaper each having stacked vertical dimension as the newspaper, which are then stacked on the setting and delivering conveyer 7.

This setting and delivering conveyer 7 is operated intermittently. That is, at a time when the continuous web 1 (sheets of newspaper pages) cut by the cutter 6 are stacked on the conveyer 7 by eight sheets, i.e. 32 pages, which corresponds to the printed amount in one printing cycle mentioned above, the conveyer 7 is slightly moved so that the stacked newspaper sheets are slightly moved. This process is repeated and, then, the sets of the newspapers, each including 32 pages, are piled and moved with slightly shifted state from each other in the delivering direction. The newspapers on the conveyer 7 are delivered in this state by a predetermined stroke or to the terminal end of the conveyer 7 and then taken out one by one each as one set of newspaper.

In the described embodiment, for example, if it is required to produce the newspaper of 16 pages, the number of lateral rows to be printed by one printing cycle is set to two (two lateral rows), and on the other hand, in the case of the newspaper of 40 pages, the number of lateral rows to be printed by one printing cycle are set to five (five horizontal rows). In these states, the printings are carried out repeatedly in both the cases.

Moreover, in the described embodiment, although there is described the example using the double-width continuous web 1, a single-width continuous web may be also used. Accordingly, in the case of the single-width web, the number of the printing (printed) surfaces in each lateral row in the double-side printing machine 2 is half (½) of the double-width web, so that the number of lateral rows to be printed in one printing cycle becomes twice of the case of the double-width web.

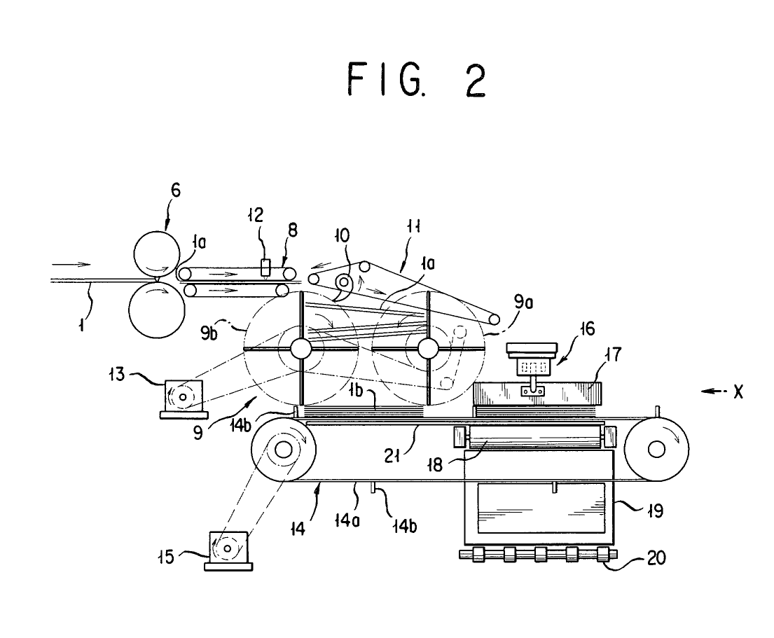

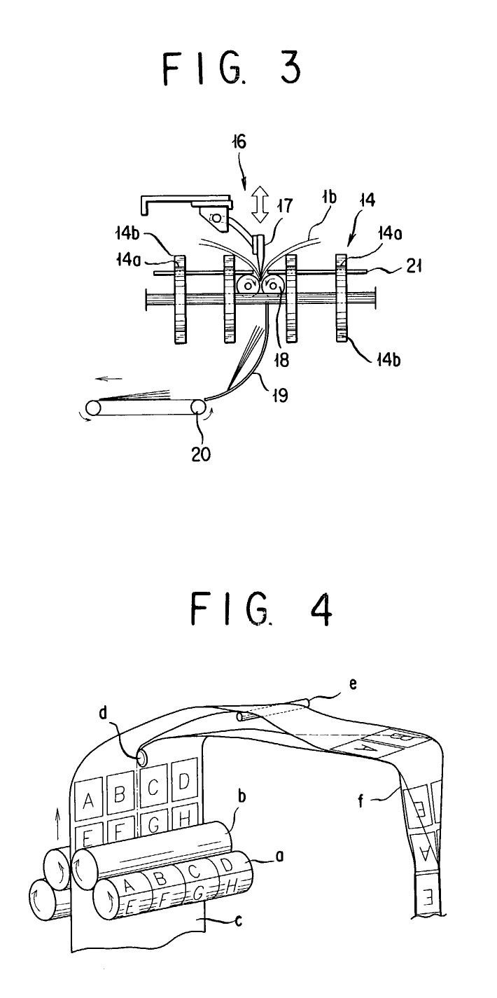

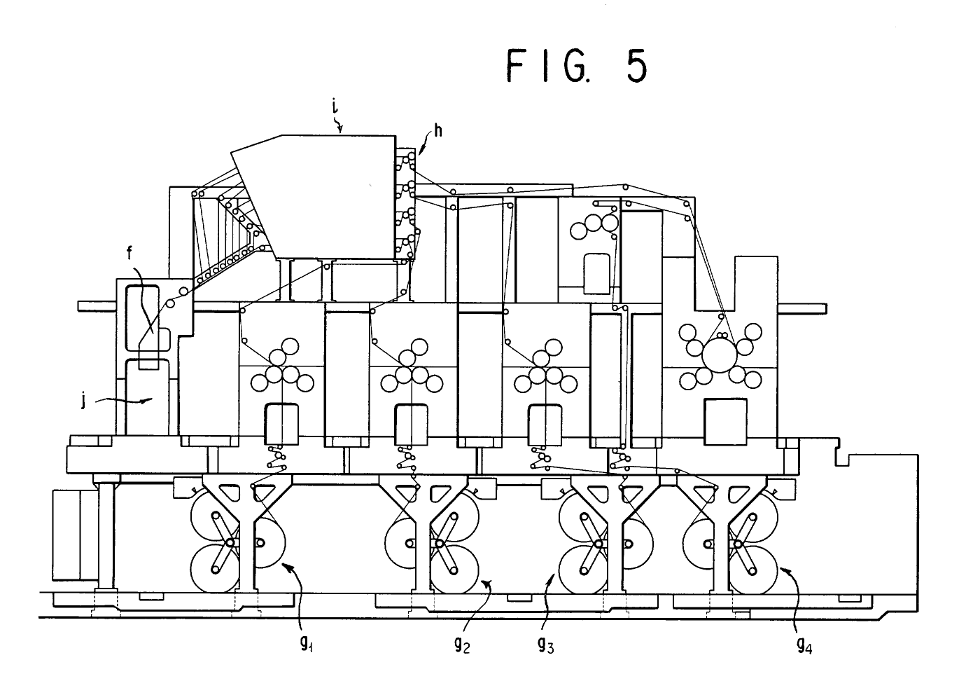

FIG. 2 shows the arrangement of another example of the setting and delivering process. With reference to FIG. 2, the cut webs 1a cut by the cutter 6 are delivered intermittently one by one on an intermittently operating impeller device 9 by a delivering belt conveyer 8 at a delivering speed V2 slightly (about 5%) faster than an operating speed V1 of the printing machine itself. The cut webs 1a abuts against a blade or vane, in an upright attitude, of a downstream side impeller 9a and then stacked on other blades, in horizontal attitude, opposing to each other, of the downstream side impeller 9b and upstream side impeller 9a. Further, in FIG. 2, reference numeral 10 denotes a striker and 11 denotes a guide belt.

In this example of FIG. 2, the cut webs 1a stacked on the intermittent impeller device 9 are counted by a sensor 12 provided for the delivering belt conveyer 8, and for example, when four sets of two-ply cut webs 1a for the preset number of pages (sheets) of for example 32-page newspaper pass the sensor 12, a servo-motor 13 instantaneously drives the intermittent impeller device 9 to thereby rotate both the impellers 9a and 9b by 90 degrees so as to move downward the opposing blades in the horizontal attitude. Accordingly, the newspapers drop on the intermittent conveyer 14 every one set.

The intermittent conveyer 14 is intermittently driven by a servo-motor 15, and according to this intermittent motion, the set web 1b dropping on the intermittent conveyer 14 is delivered to a chopper folding device 16 disposed on the downstream side of the intermittent conveyer 14. Then, at this position, the web 1b is folded in folio, by a chopper blade 17 moving downward, at just intermediate position in the width direction thereof and discharged on a delivery conveyer 20 along a guide 19 by means of chopper roller 18.

The intermittent conveyer 14 comprises a plurality of timing belts 14a which are horizontally arranged with interval from each other, and pressing plates 14b for feeding the set web 1b under pressed state are provided for the surfaces of the timing belts 14a. The chopper folding device 16 is provided with a bottom board or plate 21 for supporting the set web 1b.

Further, in the described embodiment, as means for setting and delivering the cut web 1a cut by the cutter 6 onto the intermittent conveyer 14, as shown in FIG. 2, there is utilized an intermittently driving impeller device comprising a pair of impellers which intermittently rotate. However, this means may be a known continuous rotary-type impeller device in which the cut webs are subsequently inserted into a portion between blades of a continuously rotary-type impeller device having a number of blades in its circumferential direction and, then the cut web 1a abuts against a baffle plate according to rotation of the impeller and drops on the intermittent conveyer.

It is further noted that, although the present invention is disclosed with reference to the preferred embodiment of the newspaper producing method, the present invention is not limited to such specific embodiments, and many other applications will be suggested for those skilled in the art. Furthermore, it will be caused for experts in this art field to make various amendments, modifications and changes in the details of the illustrated and described embodiments so as to be conformed with design or like or with the necessity of the applications.

What is claimed is:

1. A method of producing newspaper comprising the steps of:
printing both sides of continuous web repeatedly in a printing direction, said printing step including a plurality of printing cycles each in which a plurality of lateral printing rows having different contents from each other and each having at least two printing surfaces in a width direction of the continuous web, are printed on both sides of the continuous web correspondingly to each other;
cutting the printed continuous web with respect to each of the lateral printed rows and each two-page spread of newspaper and setting and delivering a set of the cut webs at every printing cycle; and
folding each set of the cut webs sheet at a longitudinal central portion of two-page spread thereof.

2. A method of producing newspaper according to claim 1, wherein both sides of the continuous web are printed at a portion thereof traveling in a vertical direction.

3. A method of producing newspaper according to claim 2, wherein said printing step is performed by using a digital printing machine including printing heads opposite to both sides of the continuous web, respectively, said printing head being arranged opposite to each other at the same level in the printing direction.

4. A method of producing newspaper according to claim 2, wherein said printing step is performed by using a digital printing machine including printing heads opposite to both sides of the continuous web, said printing head being arranged at different levels offset in the printing direction.
